(19) United States
(12) Patent Application Publication
(10) Pub. No.: US 2002/0064759 A1
(43) Pub. Date: May 30, 2002

(54) Method and system for viewing, altering and archiving digital models of dental structures and computer integrated manufacturing of physical models of dental structures

(76) Inventors: Duane Milford Durbin, San Diego, CA (US); Dennis Arthur Durbin, Solana Beach, CA (US)

Correspondence Address: Duane Durbin, 7660 Norcanyon Way, San Diego, CA, 92126, US

(21) Appl. No.: 09/727,152

(22) Filed: Nov. 30, 2000

(51) Int. Cl. A61C 11/00

(52) U.S. Cl. 433/213; 433/24

(57) ABSTRACT

Methods and systems for treating teeth include capturing a digital dental model taken within an oral cavity; modifying the digital model in planning a dental treatment or in designing a dental prosthetic; and creating a physical model from the original or modified digital models.

### BACKGROUND

The present invention relates to digital dental models and prosthetics generated using digital dental models.

In many dental applications, a working or study model of a patient's teeth is needed that faithfully reproduces the patient's teeth and other dental structures, including the jaw structure. Conventionally, a three-dimensional negative model of the teeth and other dental structures is created during an impression-taking session where one or more U-shaped trays are filled with a dental impression material and the tray is then placed over the teeth to create a negative mold. Once the impression material has hardened, the tray of material is removed from the teeth and a plaster like material is poured into the negative mold formed by the impression. After hardening, the poured plaster material is removed from the impression mold and, as necessary, finish work is performed on the casting to create the final working model of the dental structure. Typically a working model will include at least one tooth and the adjacent region of gingiva. Working models may also include all of the teeth of a jaw, the adjacent gingiva and, for the upper jaw, the contour of the palate.

In comparison with a working model, a study model generally reflects the complete dental structure and a higher degree of workmanship and finish. The creation of a study model from the casting typically requires a number of additional steps beyond those involved with making a working model. These additional steps include the bonding of the casting with a study model base, the preparation of surface flats that register the alignment of the upper and lower jaws to accurately reflect the patient's bite and the polishing of the model surfaces. Typically, impressions are taken in a dentist's office and then the impression is shipped to a dental laboratory where the working model or study model is made using the negative impression mold. Once completed, study models are shipped to the dentist's office where the study model is used to diagnose and plan the dental treatment. Such diagnosis and planning can include using the study model to make dimensional measurements of the teeth, arch widths, bite alignment and teeth spacing. Typically, the measurement data is recorded and saved as part of the patient record. At times, as a means of performing a ‘what if’ assessment, the individual teeth may be cut out of the model and than repositioned back onto the model jaw using a material such as wax to hold the teeth in place. This wax up technique allows the dentist to assess contemplated treatments such as removal of a tooth to relieve crowding, or widening of an arch to improve bite alignment. In dental specialty fields such as orthodontia the convention is to retain the study models used during treatment for at least seven years after the treatment has ended. Generally the patient volume of an orthodontist is of a sufficient quantity that over time the stored models exceed the storage space available in the typical practice's office and additional storage space must be obtained. Because the models are considered part of the patient record, the storage space must provide the environmental conditions necessary to preserve the integrity of the fragile study model over the entire period of the contemplated storage. Furthermore, inventory records of the stored models must be maintained with sufficient detail such that a particular study model may be reasonably located and retrieved from storage. Over time, the number of storage location sites used by an individual practice tends to multiply, further compounding the task of keeping an accurate inventory of stored models.

In contrast with study models primarily used by orthodontists and dentists, the primary user of working models are dental laboratory technicians. Dental laboratories typically use the working model as a pattern for the fabrication and fitting of a variety of precision fitted dental prosthetic devices such as crowns, bridges, retainers and veneers. Often, the technician performs a significant amount of work on the model to prepare it as the pattern for the dental fabrication. For example, a single tooth may be isolated from the model by cutting it out. The cut out tooth is then mounted at the tooth base on a short stem. The short stem provides a means of handling the isolated tooth during the subsequent steps involved in using the tooth isolation as a pattern for the prosthetic part being fabricated. Further, the isolated tooth model may be laser scanned or imaged to create a digital 3D model of the tooth. The resultant digital model of the tooth is typically used to fabricate a single tooth prosthetic using computer integrated manufacturing technology.

A number of shortcomings are present with the current impression and modeling process. The impression process can be error-prone. For example, when the impression material is not properly applied, the resulting working model may not accurately reflect features on the teeth. Moreover, the model can show air bubbles trapped during the impression taking session. The impression material may dimensionally change between the time the impression is taken and the time that the physical model is cast. Factors such as temperature, humidity and general handling can cause significant dimensional changes in the impression and lead to inaccuracies in the working and study models. Attempting to make multiple castings from the same impression can introduce additional errors into the model due to tearing and delamination of the impression elastomer. Depending upon the accuracy required, working models or study models cast from these “used” impressions may not be usable and additional dental impressions may need to be taken. Further, the mold and working model are fragile and can be easily damaged. It may be one to two weeks between the time an impression is taken and a study model is available to the dentist. This delays the diagnostics and treatment planning process and can result in additional patient appointments.

Using the cast models to perform steps such as dimensional measurements, bite alignment analysis, preparing wax ups or preparing tooth isolations is time consuming and must be carefully done to avoid damaging the model's dental structure details needed to fabricate a dental prosthetic with a precision fit. Diagnostic and treatment planning procedures such as wax ups and tooth isolations result in the destruction of the original casting and may necessitate the need to cast and finish additional models or even take a new impression so that an accurate model may be cast from a fresh impression and kept as a patient record. The need to store the fragile models as a patient record for future reference tends to become a logistical problem for a dental practice as the number of archived models accumulates.

Automated dental structure scanning techniques have been developed as alternatives to the mold casting procedure. Because these techniques can create a direct digital representation of the dental structures, they provide the advantage of creating an “impression” that is immediately transmittable from the patient to a dental CAD system and after review and annotation by a dentist to a dental laboratory. The digital transmission potentially diminishes inconvenience for the patient and eliminates the risk of damage to the impression mold. For example, U.S. patent application titled METHOD AND SYSTEM FOR IMAGING AND MODELING DENTAL STRUCTURES filed on Oct. 22, 2000 by Duane M. Durbin and Dennis A. Durbin discloses a method and apparatus for mapping the structure and topography of dental formations such as peridontium and teeth, both intact and prepared, for diagnosis and dental prosthetics and bridgework by using an intra-oral image scanning technique. As claimed therein, the method can provide a digital 3D model that captures details of orally situated dental formations thus enabling diagnosis and the preparation of precision moldings and fabrications that will provide greater comfort and longer wear to the dental patient. For those digital model files that are to be used for archiving a patient record or transferred to a remote location for the fabrication of dental prosthetic devices and appliances, a system for insuring the authenticity and security of these files is needed.

CAD systems have been developed for use by orthodontists using digital models created by scanning physical study models. With these systems, the orthodontist either ships the impression set or, once the orthodontist receives the physical study model they ship the physical model, to a site that uses the impression set or physical model as the pattern for creation of the digital model. The resultant digital model file is than sent to the orthodontist for viewing on a computer monitor. These systems are not ideal for treatment planning since they add an additional time delay to the start of treatment. In addition, the features needed for prosthetic creation and evaluation are not addressed in these orthodontic CAD systems.

### SUMMARY

In one aspect, a method for treating teeth includes scanning a dental structure to generate an authenticated digital dental model; allowing authorized users to modify the authenticated digital model in planning a dental treatment or in designing a dental prosthetic; securely transferring the authenticated digital models over a wide area network such as the Internet; creating a physical model from the original or modified authenticated digital models; and archiving the authenticated digital models.

Implementations of the above aspect may include one or more of the following. A dental Computer Aided Design (CAD) system can be used to view the authenticated digital model and create virtual study models. The dental CAD system can be used to perform diagnostic and treatment planning with the model. A Computer Integrated Manufacturing (CIM) system can create a physical study model representative of the authenticated digital model. The digital model can be viewed as a virtual 3D image of the teeth. A virtual procedure can be performed and assessed using the digital model. The virtual procedure can include moving teeth to a new position, removing a tooth entirely, or removing material from a tooth to prepare it for a restoration. The dental model can be stored as an authenticated digital file, and the file may be used to manufacture a physical working model or study model of the dental structure using computer integrated manufacturing technology. The model can be used for dental diagnosis. The authenticated model can be used to specify and manufacture dental prosthetics, including bridgeworks, crowns or other precision moldings and fabrications. Data representing an authenticated set of digital models can be encrypted and communicated or transmitted over a wide area network. The data can be transmitted to support fabrication of physical models, professional consultation, or insurance provider reviews. The method includes archiving the authenticated digital model.

In another aspect, a system for treating teeth includes means for scanning a dental structure to generate an authenticated digital dental model; allowing authorized users to modify the authenticated digital model in planning a dental treatment or in designing a dental prosthetic; means for creating a physical model from the original or modified authenticated digital models; and archiving the authenticated digital models.

In yet another aspect, a system for treating teeth includes a scanner to generate an authenticated digital dental model; a dental computer aided design system coupled to the scanner for allowing authorized users to modify the digital model in planning a dental treatment or in designing a dental prosthetic; a three dimensional solid generator coupled to the dental computer aided design system for creating a physical model from the original or modified authenticated digital models; and archival storage of the authenticated digital models.

Implementations of the above aspect may include the following. A file accessible to the dental computer aided design system can digitally authenticate and archive the models. The authenticated file can be used to manufacture a physical working model or study model of the dental structure using computer integrated manufacturing technology. The Computer Aided Design (CAD) system can be used to view the digital model and create virtual study models. The CAD system can be used to perform diagnostic and treatment planning with the model. A Computer Integrated Manufacturing (CIM) can communicate with the CAD system to create a physical study model representative of the authenticated digital model. The three dimensional solid generator can be a stereolithography machine.

The above methods and systems support viewing authenticated digital dental models taken within the oral cavity, allowing authorized users to modify the digital models to aid in treatment planning or prosthetic design, creating physical models from the original or modified authenticated digital models, and digitally archiving the authenticated models. The method and system include: a) utilization of a dental Computer Aided Design (CAD) system to view the digital model and create virtual study models; b) a utilization of a dental CAD system to perform diagnostic and treatment planning with the virtual models; c) utilization of Computer Integrated Manufacturing (CIM) to create an accurate physical working model or physical study model that is representative of the virtual model created by the dentist using the CAD system; d) creation of authenticated digital model files for secure archival; and e) creation of authenticated digital model files for encrypted transfer over the Internet to valid users at remote locations.

The system allows digital 3D models of dental structures to be viewed as a virtual 3D image of the dental model. The view perspective is selectable by the user and the user can interact with the virtual 3D model to perform treatment planning and predictions. For example, the system provides the user with the ability to alter the image of the 3D model by virtually performing procedures such as moving teeth to a new position, or removing a tooth entirely, or removing material from a tooth to prepare it for a restoration. The ability to perform, these virtual procedures allows the dentist to quickly plan and assess a contemplated course of treatment for the patient. The reviewed and possibly altered (e.g. tooth isolation) 3D images are processed as an authenticated digital file that may be used to manufacture a physical working model or study model of the dental structure using computer integrated manufacturing technology.

For treatments involving dental restorations, the virtual 3D models and physical models derived therefrom have application in dental diagnosis and for the specification and manufacture of dental prosthetics such as bridgeworks, crowns or other precision moldings and fabrications. In addition, the models have utility in the diagnosis and treatment planning process for dental malocclusions. The subject invention allows the data representing one or more authenticated digital 3D models to be encrypted and transmitted securely to remote locations to support activity such as fabrication of physical models, professional consults or insurance provider reviews. The authenticated digital 3D models may be electronically archived for future reference.

Other aspects of the present invention are described in the following detailed description of the invention, in the claims and in the accompanying drawings.

### BRIEF DESCRIPTION OF THE DRAWINGS

FIG. 1 is a block diagram illustrating an exemplary environment for viewing, altering, and archiving digital models of dental structures and for supporting computer integrated manufacturing of physical models of the dental structures.

FIG. 2 shows a system and method for viewing digital dental models and performing treatment planning.

FIG. 3A depicts exemplary features and geometry of a virtual dental study model.

FIG. 3B shows an exemplary process for using the virtual dental study model.

FIG. 4 shows a process to edit a teeth model.

FIG. 5 illustrates an example of a CIM generated tooth.

FIG. 6 shows an exemplary system for providing secure transmission of authenticated digital models over the Internet.

### DESCRIPTION

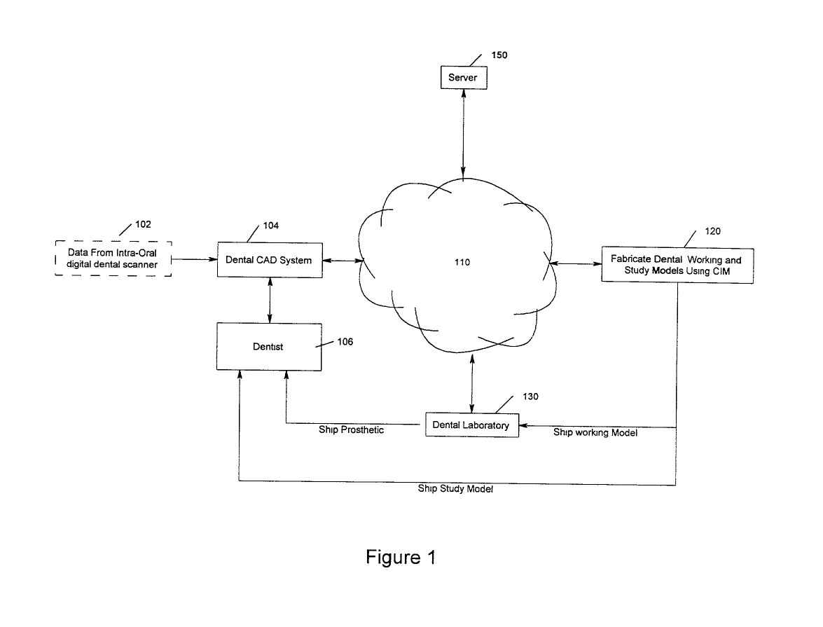

FIG. 1 is a block diagram that illustrates an exemplary environment for viewing, altering, and archiving digital models of dental structures and for supporting computer integrated manufacturing of physical models of the dental structures. In the environment of FIG. 1, data obtained by an intra-oral scanner 102 of the dental structures is used to create a digital 3D surface contour of the scanned dental structures. Descriptions of the method and apparatus to obtain this digital dental model are described in a pending U.S. patent application entitled “METHOD AND SYSTEM FOR IMAGING AND MODELING DENTAL STRUCTURES”, filed on Oct. 22, 2000 by Duane M. Durbin and Dennis A. Durbin, the contents of which are incorporated by reference herein.

The data representing the digital dental working model from the scanner 102 is transferred to a Dental CAD System 104 where a dental service provider 106 such as a dentist may view a 3D image that is representative of the scanned structures. Once the dental service provider 106 reviews and accepts the model, the CAD system 104 authenticates the digital model file by use of a digital watermark. Using the CAD system 104, the dentist may also create virtual study models and use these models to perform a variety of diagnostic and treatment planning processes. If the dentist desires a physical working model or physical study model, the authenticated data file that represents the desired 3D model may be encrypted and transferred over a wide area network 110 such as the Internet to a facility 120 with computer aided manufacturing capabilities. This facility would utilize methods and technologies such as Stereo Lithography Apparatus (SLA) to fabricate an accurate and detailed physical model that is representative of the virtual model prepared and specified by the dentist. Typically, a CIM fabricated study model would be shipped directly back to the dentist.

The treatment plan may involve the requirement to fabricate a prosthetic such as a crown. Using the case of a crown restoration as a representative example, the dentist typically will prepare the tooth (or teeth) to be crowned in the normal fashion and then take an intra oral scan to create a digital working model. The Dental CAD System 104 is used to view the virtual dental working model. Depending on the particular case, the virtual working model may include the entire jaw or it may be limited to a single isolated tooth or group of teeth. Once the dentist has completed the treatment planning, the data file that represents the desired 3D working model may be digitally watermarked for authentication and then encrypted and transferred over the Internet to the facility 120 with computer aided manufacturing (CIM) capabilities. This facility would decrypt the file and utilize the digital watermark to verify authenticity of the file and then utilize methods and technologies such as Stereo Lithography Apparatus (SLA) to fabricate an accurate and detailed physical model that is representative of the virtual model prepared, specified and authenticated by the dentist. Typically the fabricated working model will include at least one tooth and the adjacent region of gingiva. The fabricated working model may also include all of the teeth of a jaw, the adjacent gingiva and, for the upper jaw, the contour of the palate. After manufacture, the fabricated working model is typically sent to a dental laboratory 130 where the physical working model is used as the pattern for fabricating a precision fitting prosthetic. Once completed, the prosthetic device is shipped to the dentist for fitting on the patient.

In some cases, the dentist may transfer the authenticated digital working model file directly to the dental laboratory 130. The dental laboratory 130 may choose to make dentist-sanctioned modifications to the virtual model and then forward the modified file over the Internet to the CIM facility 120 that will fabricate the physical working model. An additional digital watermark added during the modification process provides authenticity for the modified file while also signifying that the new file is derived from modifications to a previously authenticated file. Typically, any modifications made would be related to the model base or tooling interface features and not involve the model's representation of the dental structure or associated details. Once the physical model has been ordered from the CIM facility 120, the processes described previously for the CIM facility would be followed.

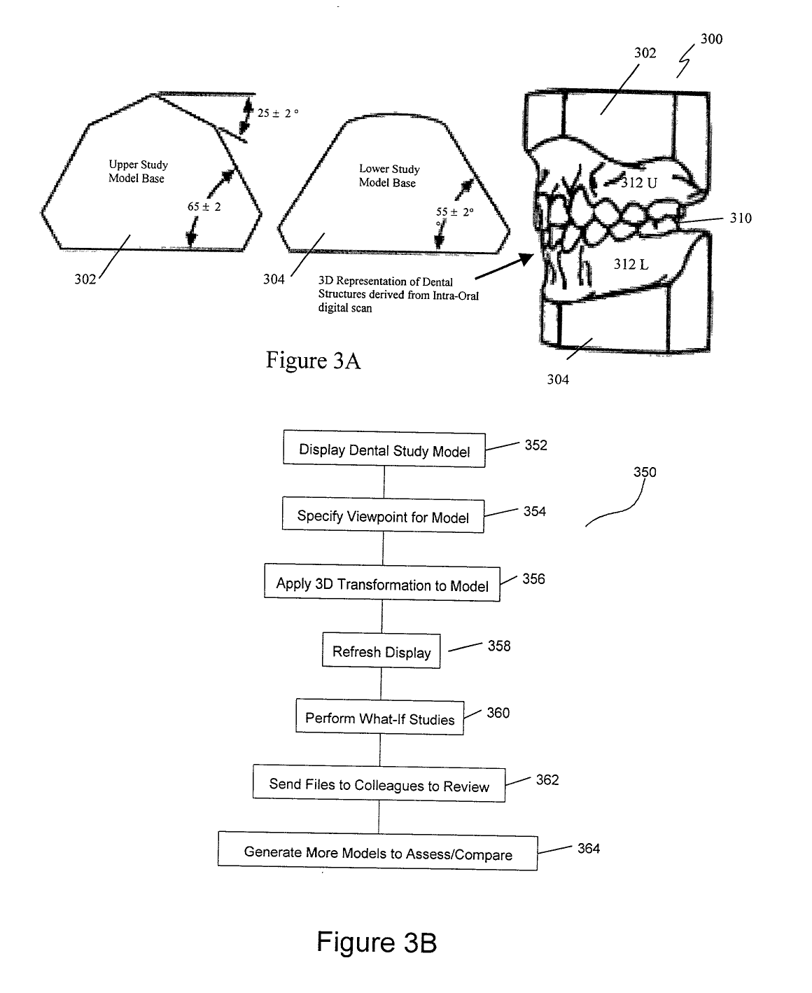

The system of FIG. 1 integrates the creation of virtual dental models with CIM to fabricate accurate physical representations of the virtual models. The invention addresses the CIM of physical replicates ranging from an individual tooth model to a full study model integrated with the base geometry depicted in FIG. 3 and aligned to reflect the patient's bite registration. The CIM technologies that are suitable for fabrication of physical replicates of the virtual models includes, but is not limited to stereo lithography apparatus (SLA), computer numeric controlled (CNC) machining, electro-discharge Machining (EDM), and Swiss Automatics machining. For example, SLA equipment and 3D printers such as the ThermoJet printer are available from 3D Systems, Inc. of Valencia, Calif. that allows CAD users the freedom to quickly “print” and hold a 3-dimensional model in their hands.

In stereolithography, three-dimensional shape model data is converted into contour line data and sectional shapes at respective contour lines are sequentially laminated to prepare a cubic model. Each cubic ultraviolet-ray curable resin layer of the model is cured under irradiation of a laser beam before the next layer is deposited and cured. Each layer is in essence a thin cross-section of the desired three-dimensional object. Typically, a thin layer of viscous curable plastic liquid is applied to a surface which may be a previously cured layer and, after sufficient time has elapsed for the thin layer of polymerizable liquid to smooth out by gravity, a computer controlled beam of radiation is moved across the thin liquid layer to sufficiently cure the plastic liquid so that subsequent layers can be applied thereto. The waiting period for the thin layer to level varies depending on several factors such as the viscosity of the polymerizable liquid, the layer thickness, part geometry, and cross-section, and the like. Typically, the cured layer, which is supported on a vertically movable object support platform, is dipped below the surface of a bath of the viscous polymerizable liquid a distance greater than the desired layer thickness so that liquid flows over the previous cross-section rapidly. Then, the part is raised to a position below the surface of the liquid equal to the desired layer thickness, which forms a bulge of excess material over at least a substantial portion of the previous cross-section. When the surface levels (smooth out), the layer is ready for curing by radiation. An ultraviolet laser generates a small intense spot of UV which is moved across the liquid surface with a galvanometer mirror X-Y scanner in a predetermined pattern. In the above manner, stereolithography equipment automatically builds complex three-dimensional parts by successively curing a plurality of thin layers of a curable medium on top of each other until all of the thin layers are joined together to form a whole part such as a dental model.

The system of FIG. 1 also includes a computer server 150 that is attached to the Internet. This server provides the communication and coordination interface between all of the other system elements connected via the Internet. The server 150 provides system security by authenticating all requested data file and information transfers taking place on the system over the Internet. The server 150 also provides the transaction monitoring function that is utilized to bill clients on a ‘fee per use” basis and provides a secure method of assessing client account information.

Although the server 150 can be an individual server, the server 150 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

In one exemplary environment, the server 150 can also be protected by a firewall. When the firewall receives a network packet from the network, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 150. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 150 supports a dental portal that provides a single point of integration, access, and navigation through the multiple enterprise systems and information sources facing dental service providers. The portal can additionally support services that are transaction driven. One such service is advertising: each time the user accesses the portal, the user workstation downloads information from the server 150. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Website. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal. The advertisements will be targeted to the user's specific needs.

Additionally, the portal offers contents and forums providing focused articles, valuable insights, questions and answers, and value-added information about related issues, including information on dental and financing issues.

Other services can be supported as well. For example, a user can rent space on the server to enable him/her to download application software (applets) and/or data anytime and anywhere. By off-loading the storage on the server, the user minimizes the memory required on the client workstation, thus enabling complex operations to run on minimal computers such as handheld computers and yet still ensures that he/she can access the application and related information anywhere anytime. Another service is Online Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

Additionally, the server can operate in a co-branding mode where one or more partners operate storefronts while the server performs processing relating to various dental transactions. The portal can thus appear as a co-branded portal, that is, the portal appears to be offered and managed by the partners. However, it is actually supported by the server, and the partner is only lending its name to the portal.

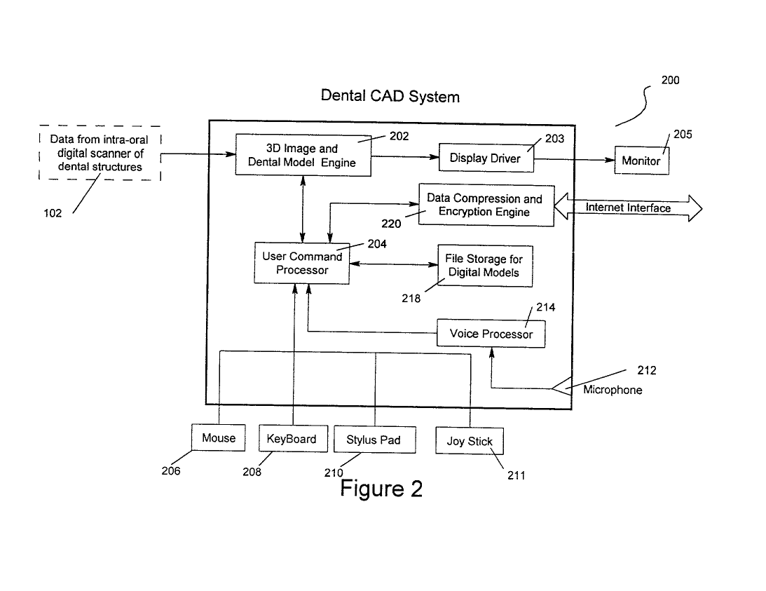

Referring now to FIG. 2, a system 200 for viewing digital dental models and performing treatment planning is presented. Data from an intra-oral dental scanning such as from an intra-oral scanner is processed by a 3D image engine 202 and displayed as a scaled 3D view of the dental structures.

The 3D image engine 202 also assesses the quality of the acquired digital model and can display to the user highlighted regions where the model reflects an anomalous surface contour, or where uncertainties in the calculated estimate of the surface contour exceeds a user specified limit. The output of the 3D image engine 202 is provided to a display driver 203 for driving a display or monitor 205.

The 3D image processor 202 communicates with a user command processor 204, which accepts user commands generated locally or over the Internet. The user command processor 204 receives commands from a local user through a mouse 206, a keyboard 208, or a stylus pad 210 or joystick 211. Additionally, a microphone 212 is provided to capture user voice commands or voice annotations. Sound captured by the microphone 212 is provided to a voice processor 214 for converting voice to text. The output of the voice processor 214 is provided to the user command processor 204. The user command processor 204 is connected to a data storage unit 218 for storing files associated with digital models.

While viewing the 3D representation of the digital model, the user may use mouse 206, keyboard 208, stylus pad 210, joy stick 211 or voice inputs to control the image display parameters on the monitor 205, including, but not limited to, perspective, zoom, feature resolution, brightness and contrast. Regions of the 3D representation of the digital model that are highlighted by the CAD system as anomalous are assessed by the user and resolved as appropriate. Following the user assessment of the 3D image of the digital working model, the dental CAD system provides the user with tools to archive a watermarked file of the 3D model. A digital watermark aims to identify the origin, author, owner, usage rights, distributor, or authorized user of an image. Although digital watermarking is relatively new as a means of protecting intellectual property, the theories and technologies behind it are derived from computer-based steganography (cryptography), spread-spectrum communications, and noise theory. The process of watermarking encodes the hidden information as additional noise and incorporates it in the document. Modifications of the original's noise signal caused by moderate levels of wideband noise or controlled reduction of noise are not visible.

Most common watermarking methods for graphics signals work in the spatial, time, or frequency domains. The advantage of frequency-domain watermarking is that the watermark is spread throughout the whole image and hence is resistant to cropping or cutting. However, a standard frequency filter, or a lossy compression algorithm, which usually filters out the less significant frequencies, could damage the watermark. Watermarks can also be embedded in an image's luminance and color bands, or in the contour and texture of an image. Common watermarking methods use the luminance band since it contains the most significant information of a color image.

Direct-sequence and frequency-hopping spread-spectrum techniques are the major watermark embedding methods used in existing tools. Both modify the noise value of the target documents. The direct-sequence technique adds noise to every element of the document, whereas the frequency-hopping method selects a pseudorandom subset of the data to be watermarked. Other systems use secret keys to determine which lines or words of a text will be slightly shifted vertically or horizontally. Hiding secret messages in the least-significant bits of some pseudorandom frequencies or pixels of an image, which is a common approach employed in many steganographic tools, can also be considered a simple example of frequency hopping. Because frequency hopping modifies only a subset of pixels or other elements of a document, it tends to be much faster than direct-sequence methods. It is, however, less robust and more vulnerable to attack.

Watermark extraction includes two main steps: selecting the locations where the watermark has been inserted (only in frequency hopping) and retrieving the watermark from those locations. The retrieval process normally needs either the original, unwatermarked data or the added noise for comparison with the watermarked document. It is also possible to extract the watermark without the original data. In this case the algorithm detects specific properties and patterns from the watermarked document. These patterns can be represented as signal shapes or the cross-correlation between certain document elements. This retrieval method is generally more efficient and enables one to retrieve watermarks in real time. A watermark must be extractable even if the file has been manipulated by imaging programs. If a file does not have the same format, resolution, or physical size as the original, it has to be normalized to the original format before the watermark can be extracted. Typical normalization processes include format conversion, resampling, enlarging a cropped part to full size, and scaling of the signal level.

The dental CAD system also provides the user with tools to perform a variety of treatment planning processes using the dental 3D models. Such planning processes include measurement of arch length, measurement of arch width, and measurement of individual tooth dimensions. The CAD system also provides the user with the capability to create a virtual study model from the digital working model including the fusing of digital occlusal alignment data to register the upper and lower jaw positions of the virtual model. The virtual study model creation process also fuses the digital working model of both jaws with the model bases depicted in FIG. 3. In addition, available Digital X-Ray data for the patient will be registered, scaled and fused with the digital working model data to generate a virtual 3D model that includes a synthesized 3D view of the teeth root structures.

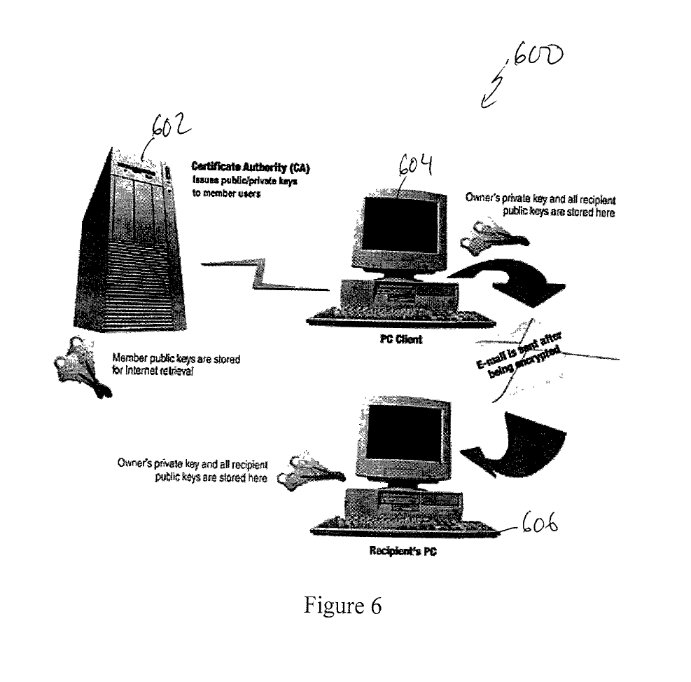

The system of FIG. 2 also includes a data compression and encryption engine 220 to process data being exchanged over the Internet. Corresponding data compression and encryption engines are employed by the server, the CIM facilities and the dental laboratories communicating system data over the Internet. The system provides for the encryption keys to be managed, controlled and distributed by the system server 150. Data files associated with the digital dental models and the virtual model files derived there from are saved in computer memory on the dental CAD system and available for retrieval or transmittal to a remote location. FIG. 6 illustrates an encrypted messaging system using asymmetric cryptography. Asymmetric cryptography involves two related keys, referred to as a ‘key-pair’, one of which only the owner knows (the ‘private key’) and the other which anyone can know (the ‘public key’).

The advantages of asymmetric cryptography are that:

only one party needs to know the private key; and

knowledge of the public key by a third party does not compromise the security of data transmissions.

The public and private keys are derived as factors of a much larger number that is created by the encryption software. The original number created is a prime number (a number that is evenly divisible only by one and itself). The software then factors this large prime number into two non-integer factors, pieces that (when multiplied together) form the whole prime number. The encryption software creates the public and private keys from these factors. To securely transfer a file, the sender encrypts the message, not with their own key, but using the intended recipient's public key. The receiver decrypts using their private key. This is a more secure approach than symmetric cryptography, because the decryption key need never be in the possession of anyone other than the owner.

The key-pair technique can also be used to address all of the integrity, authentication and non-repudiation requirements. Note that this process uses a different key-pair from that used for message transmission security. The key-pair used for message security is owned by the recipient, whereas the key-pair used in this process is owned by the sender. The sender appends to a message a special, agreed segment within the message. He encrypts this segment with his private key. The recipient decrypts this segment using the sender's public key. If the decrypted segment is identical to what the two parties had previously agreed, then the recipient can be sure that the message has been sent by the purported sender, and that the sender cannot credibly deny having sent it. Hence the authentication and non-repudiation requirements are satisfied.

This technique can be taken a step further, to address the integrity requirement as well. The additional segment is not pre-agreed. Instead, a ‘message digest’ is created, by processing the actual message using a special, pre-agreed algorithm. The sender encrypts this message digest with his private key, to produce what is called a ‘digital signature’ (because it performs much the same function as a written signature, although it is much harder to forge). The recipient re-creates the message digest from the message that they receive, uses the sender's public key to decrypt the digital signature that they received appended to the message itself, and compares the two results. If they are identical, then:

the contents of the message received must be the same as that which was sent (satisfying the integrity requirement);

the message can only have been sent by the purported sender (satisfying the authentication requirement); and

the sender cannot credibly deny that they sent it (satisfying the non-repudiation requirement).

Referring to FIG. 3A, exemplary features and geometry of a virtual dental study model 300 are depicted. The virtual study model 300 includes an upper and a lower base geometry 302 and 304. Using the virtual study model file and CIM technology, a physical model can be fabricated.

FIG. 3B shows an exemplary process 350 for using the virtual dental study model 300. First, the virtual dental study model 300 is displayed (step 352). With a suitable joystick (or keyboard or mouse selection), the user can specify a desired angle and/or viewpoint to view the virtual dental study model 300 (step 354). The process then takes the input position and applies a 3D transformation to the model 300 (step 356). The 3D model is refreshed on the monitor (step 358). Additionally, the user can perform a number of treatment ‘what if’ studies using the virtual model rather than the plaster castings currently used (step 360). For example, a tooth model may be excised virtually and the remaining teeth can be virtually rearranged to assess the final configuration and impacts on arch width and teeth spacing. As another example, the relative jaw positions may be altered (virtually) with the dental CAD system to assess the impact of contemplated jaw surgery to correct overbite or overjet. The virtual study models files and treatment plans may be transferred over the Internet to a dental colleague for activities such as professional consultation or treatment referrals to a dental specialist (step 362). As the actual treatment process progresses, additional digital models may be taken and assessed using the dental CAD system to compare the original treatment plan predictions with the current condition of the dental structures (step 364).

In planning for a tooth crown procedure, conventionally, a tooth isolation is prepared by cutting the tooth involved with the dental treatment out of a cast model made from an elastomer impression. A process discussed next provides an alternative process that utilizes a digital working model and the dental CAD system to prepare a virtual 3D model of a tooth isolation. Using this process, an operator utilizes the CAD system to isolate the tooth from the complete virtual working model and then creates a virtual 3D model of just the single tooth.

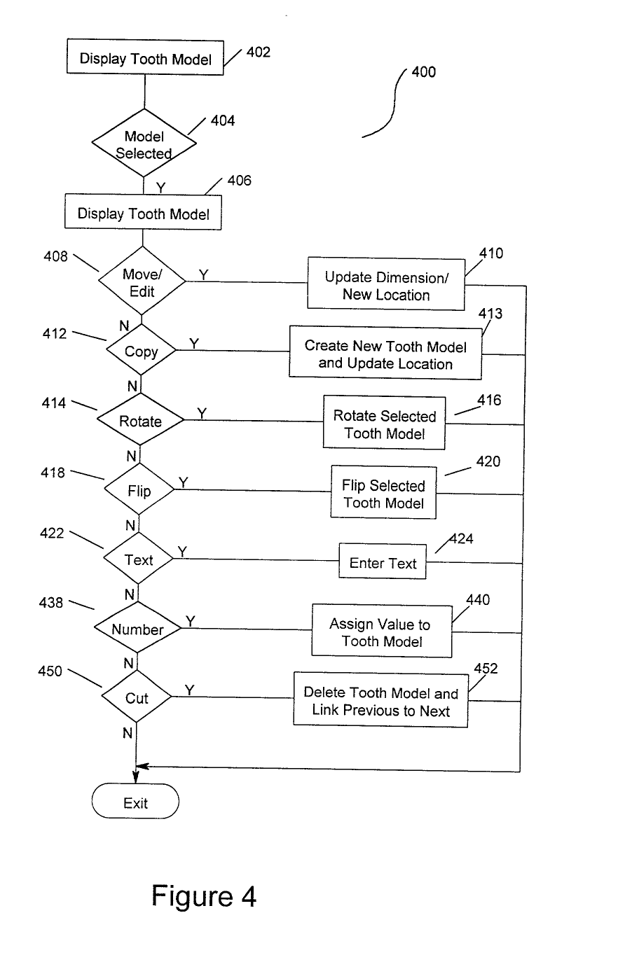

Referring now to FIG. 4, the routine or process 400 to edit a teeth model is disclosed in more detail. Upon entry, the teeth model with upper and lower arches are displayed (step 402). Next, the process checks if one or more teeth models have been selected (step 404). If not, the routine simply exits. Alternatively, if the user has specified parameters sufficient to identify one tooth model or tooth object from the rest of the teeth, the routine highlights the tooth model (406). The parameters can be a set of points delineating one or more cutting planes separating one tooth from its neighboring teeth. Alternatively, the parameter can simply be a selection of a particular tooth model which has already been embedded with dimensional information about the tooth so that 3D data on the selected tooth can be retrieved from a file.

Next, the routine determines if the tooth model or object has been moved or digitally edited (step 408). If so, the routine updates the dimensions and key points of the tooth model, as well as the new location of the tooth model if it has been moved (step 410). Using the editing capability, the routine can be used to design a base and a handling stem on the tooth model, for example. After completing step 410, the routine deselects the tooth model and exits the edit routine.

If the tooth model has not been moved or stretched, the routine tests if selected tooth model(s) is/are to be copied (step 412). If so, the routine creates new tooth models or tooth object(s) based on the selected object(s) and links these new objects to existing tooth objects before exiting the routine (step 413). Alternatively, if the user does not want to copy objects, the routine checks if the user wishes to rotate selected tooth object(s) (step 414). If the objects are to the rotated, the routine complies with the request (step 416) where the selected object(s) are rotated and their new positions are noted in the linked list data structure. Afterward, the routine deselects the object(s) and exits.

From step 414, if the tooth objects are not to be rotated, the routine checks if the user wishes to flip the tooth objects (step 418). If so, the routine flips them in step 420 and updates the location of the selected objects therein before exiting the routine. Alternatively, from step 422, the user may wish to enter text associated with the selected objects. If so, the routine allows the user to enter text and to associate the text with the selected objects (step 424) by adding the text to the linked list data structure for the objects. The text entered in step 424 may include numbers as literals. After step 424, the routine deselects the object(s) and exits.

Alternatively, from step 422, the routine checks if the user has assigned a number such as the length or width of the selected tooth object(s) (step 438). If so, the routine proceeds with step 440. The number(s) entered in step 440 is/are dimensional assignments which are entered as part of the dimensions of the tooth object(s) and the size of the object(s) is/are changed. From step 440, the routine deselects the object(s) and exits.

From step 438, if numbers are not entered, the routine checks if the user wishes to cut the selected tooth object(s) (step 450). If so, the respective object(s) are deleted and the link associated with the element immediately prior to the first selected object is linked to the element immediately after the last selected tooth object (step 452). Further, the data structures associated with the deleted objects are cleaned-up such that the memory allocated to the deleted objects is released back for other uses. From step 450 and step 452, the routine deselects the object(s) and exits.

The original data structure prior to the edit operation is temporarily archived in memory to enable the operation of the “Undo” option. The “Undo” option is useful in the event that the user wishes to change his or her mind after seeing the edited tooth object(s). Voice recognition is useful for certain data entry aspects such as the entering of text annotation and the selection of components.

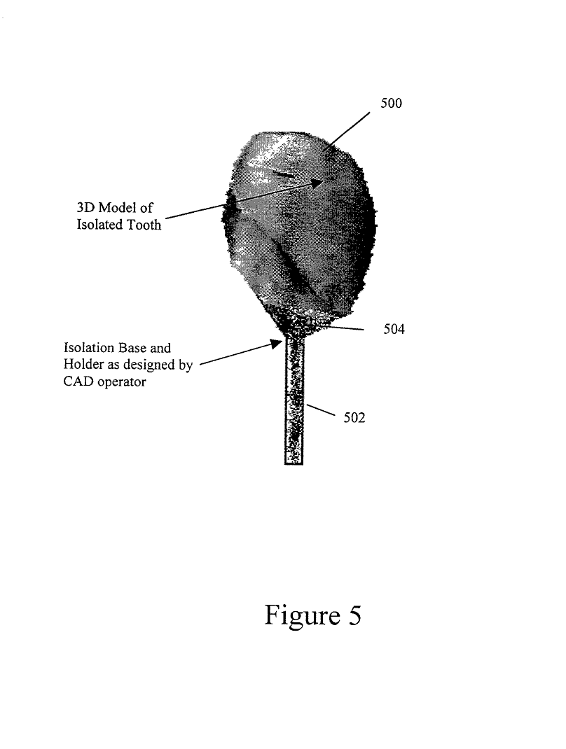

In FIG. 5, a computer model 500 of a single tooth is shown. The system of FIG. 2 is used to design a base 504 and a handling stem 502 on the tooth model 500. Once completed and checked by the dentist if needed, the digital file for the virtual model of the tooth in isolation is transferred to a facility with CIM capability where a physical 3D model is fabricated that accurately reflects the geometry and details of the virtual isolated tooth model. The fabricated physical representation of the virtual tooth isolation model is typically provided to a dental laboratory where it is used as the pattern to prepare the permanent crown for the modeled tooth.

The process described above for a single tooth crown may be extended to apply to restorative dental prosthetics in general and the virtual and physical modeling of any number of teeth.

FIG. 6 shows an exemplary system 600 having a certificate authority 602 that issues public/private keys to member users. One client computer 604 stores the owner's private key and all recipient public keys. The client computer 604 sends encrypted communications to a second client computer 606, which stores the owner's private key and all recipient public keys and decrypts the communications sent by the client computer 604.

While the present invention has been described in connection with certain preferred embodiments, it will be understood that it is not limited to those embodiments. On the contrary, it is intended to cover all alternatives, modifications and equivalents as may be included within the spirit and scope of the invention as defined in the appended claims.

1. A method for treating teeth, comprising:
scanning a dental structure to generate a digital dental model;
modifying the digital model in planning a dental treatment or in designing a dental prosthetic; and
creating a physical model from the original or modified digital models.

2. The method of claim 1, further comprising digitally archiving the models with an authentication watermark.

3. The method of claim 1, further comprising utilizing a dental Computer Aided Design (CAD) system to view the digital model and create virtual study models.

4. The method of claim 3, wherein the dental CAD system is used to perform diagnostic and treatment planning with the model.

5. The method of claim 1, further comprising using Computer Integrated Manufacturing (CIM) to create a physical study model representative of the digital model.

6. The method of claim 1, further comprising viewing the digital model as a virtual 3D image of the teeth.

7. The method of claim 1, further comprising performing a virtual procedure using the digital model.

8. The method of claim 7, wherein the virtual procedure includes moving a tooth to a new position, removing a tooth entirely, or removing material from a tooth to prepare the tooth for a restoration.

9. The method of claim 1, further comprising storing the dental model as an authenticated digital file.

10. The method of claim 1, further comprising storing the dental model as a file and accessing the file to manufacture a physical working model or study model of the dental structure using computer integrated manufacturing technology.

11. The method of claim 1, wherein the model is used for dental diagnosis.

12. The method of claim 1, wherein the model is used to specify and manufacture dental prosthetics, including bridgeworks, crowns or other precision moldings and fabrications.

13. The method of claim 1, further comprising transmitting encrypted data representing a set of authenticated digital models over a wide area network.

14. The method of claim 13, wherein the data is transmitted to support fabrication of physical models, professional consultation, or insurance provider reviews.

15. The method of claim 13, wherein the data is transmitted to support fabrication of a dental prosthetic.

16. A system for treating teeth, comprising:
means for scanning a dental structure to generate a digital dental model;
means for modifying the digital model in planning a dental treatment or in designing a dental prosthetic; and
means for creating a physical model from the original or modified digital models.

17. A system for treating teeth, comprising:
a scanner to generate a digital dental model;
a dental computer aided design system coupled to the scanner for modifying the digital model in planning a dental treatment or in designing a dental prosthetic; and a three dimensional solid generator coupled to the dental computer aided design system for creating a physical model from the original or modified digital models.

18. The system of claim 17, further comprising a file coupled to the dental computer aided design system for digitally watermarking and archiving the models.

19. The system of claim 18, wherein the file is used to manufacture a physical working model or study model of the dental structure using computer integrated manufacturing technology.

20. The system of claim 17, wherein the Computer Aided Design (CAD) system is used to view the digital model and create virtual study models.

21. The system of claim 20, wherein the CAD system is used to perform diagnostic and treatment planning with the model.

22. The system of claim 20, further comprising Computer Integrated Manufacturing (CIM) coupled to the CAD system to create a physical study model representative of the digital model

23. The system of claim 17, wherein the three dimensional solid generator is a stereolithography machine.
